(19) United States
(12) Patent Application Publication
(10) Pub. No.: US 2006/0208225 A1
(43) Pub. Date: Sep. 21, 2006

(54) Semiconductor nanocrystals as novel antennae for lanthanide cations and associated methods

(76) Inventors: Stephane Petoud, Pittsburgh, PA (US); Demetra Chengelis, Pittsburgh, PA (US); Adrienne Yingling, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/368,970

(22) Filed: Mar. 6, 2006

Related U.S. Application Data
(60) Provisional application No. 60/651,474, filed on Mar. 11, 2005.

(51) Int. Cl. C09K 11/08

(52) U.S. Cl. 252/301.6 S; 252/301.4 F

(57) ABSTRACT

The present invention relates to a new composition of luminescent matter in which lanthanide cations are incorporated into semiconductor nanocrystals, and methods for making this new composition of matter. The semiconductor nanocrystal structure serves as an antenna for allowing the excited electronic states of the semiconductor nanocrystals to sensitize lanthanide cation emission. In comparison to organic antenna types, semiconductor nanocrystals are able to protect lanthanide cations from quenching solvent molecules without supplying high energy vibrations, thereby resisting non-radiative deactivation of the lanthanide cation excited states. Semiconductor nanocrystals have several advantages as species that absorb and emit photons, namely, broad absorbance bands with high epsilon values and emission wavelengths that can be easily tuned through their size, which is controlled through synthesis conditions. Lanthanide cations also have several advantages—sharp emission bands and long luminescence lifetimes.

### FIELD OF THE INVENTION

The present invention relates to compositions of luminescent matter in which lanthanide cations are incorporated into semiconductor nanocrystals, and methods for making these compositions of matter.

### BACKGROUND INFORMATION

Semiconductor Nanocrystals

Nanometer-sized semiconductor particles, also known as quantum dots or nanocrystals, are nanomaterials, a category of matter that lies at the interface between molecules and solids. They have many size dependent physical and chemical properties that make them interesting for scientific investigation. The most commonly known of these properties is the established relationship between their size and their optical properties. Known as the size quantization effect, the smaller the particle, the higher the energy of absorption and emission. The desirability of this characteristic is boosted by the ease of synthesizing a variety of sizes from one synthetic scheme. While emission color is dependent on size, the color purity of semiconductor nanocrystal emission is dependent on the size and shape distribution of a nanocrystal sample. There are two other properties that are important to the overall efficiency of nanocrystal emission; brightness and stability. These properties depend on a well-controlled synthesis method. In addition to the size quantization effect, nanocrystals have other properties of interest, such as nonlinear optical properties, unusual fluorescence behavior such as blinking, catalytic properties, structure and phase transitions, transport properties, surface chemistry, and use as precursors for nano-structured materials processing.

In a bulk semiconductor material the electronic carriers are free in all directions, thus electrons can move freely throughout the material. When this same material is spatially confined, changes occur in the allowed carrier energies. In the bulk, the carriers exist in nearly continuous bands. However, when confined in all three directions, which is the case for nanocrystals, carriers become restricted to a specific set of completely quantized energy states. By solving for the Eigen-energies of the Schrödinger wave equation for the carriers in a confined space, the effect of this quantum confinement can be obtained. This leads to a calculated relationship between the size of the confined energy system and the resulting change in energy levels. The following equation is the simplified expression for the energy (E) of a confined system:
E=[h²αₙ²n²]/[2 mL²], (1)
where h is Plank's constant, m is some carrier effective mass that depends of the degree of confinement, αₙ is the n zeroes of the spherical Bessel function of order 1, and L is the confinement dimension. This equation shows that the resulting energy state is inversely proportional to the square of L, which means the band gap can be shifted to higher energies by spatially confining the electronic carriers.

The minimum energy required to form free carriers in a bulk semiconductor material is known as the band gap energy. Any value below this cannot excite free carriers; however, it is possible to promote an exciton at energy lower than the band gap at low temperatures. An exciton is an electron and hole that are bound to each other. Since the electron is bound to the hole, a lower energy is required to achieve this type of excitation. When a system is spatially confined, as it is in a nanocrystal, the resulting quantized energy states are formed by excitons. An exciton is similar in behavior to the hydrogen atom; as the electron orbits the hole, a set of hydrogen-like energy states are created. An electron orbiting a nucleus has a characteristic dimension, the Bohr radius. Similarly, when an electron orbits a hole in a nanocrystal exciton, it also has a characteristic dimension that is called the exciton Bohr diameter, aₓ, which is basically a measure of the diameter of the exciton. This is a material-dependent property that varies in a similar way to the band gap and is therefore a critical parameter which provides a basis on which to judge the criteria for size confinement in different materials.

As materials approach the size of the exciton Bohr radius, confinement effects must be taken into account. There are both strong and weak confinement effects which are determined by the degree of coupling between the electron and the hole. While these give different resulting energy state equations, they both lead to the same trend in the relationship between energy and crystal size: a blue-shift in energy results as the size of the crystal decreases. When nanocrystals absorb light of the appropriate wavelength and enter an excited state, excitons are created within and then recombine radiatively to create photons. Photoluminescence spectra taken of nanocrystals yield a plot of the intensity of the signal measured from the radiative recombination as a function of the wavelength being detected. This allows for directly measuring the different energy states present in a nanocrystal. As the nanocrystals increase in size, the energy from the radiative recombination of the excitons decreases. This causes emission of the photon to shift to higher wavelengths (red-shift), as predicted by quantum confinement theory. This quantum confinement effect is one of the most desirable characteristics of nanocrystals.

Nanocrystals have vast potential as a new class of fluorescent probes for many biological and biomedical applications, mostly due to their advantages over currently employed organic dyes. Since the emission spectra are narrower, symmetrical, and tunable according to size and material composition, nanocrystals allow closer spacing of different probes without substantial spectral overlap. Also, their absorption spectra are very broad, with high ε values, so it is possible to excite different sizes (and colors) of nanocrystals simultaneously with a single light source. If the appropriate wavelength is chosen, it is even possible to minimize sample autofluorescence by simply avoiding its excitation. Another advantage is increased stability. Nanocrystals exhibit much better photostability than organic dyes as they do not photo-bleach over reasonable lengths of exposure time (180 seconds). They also do not dissociate in solution, which allows them to be used at very high dilutions. Additionally, recent advances in nanocrystal research indicate that near infrared range (NIR) emission can be achieved, which is extremely useful for bioimagery applications as NIR radiation can penetrate skin, blood and other organs.

Lanthanide Cations

The lanthanide series represents the chemical elements that range from atomic numbers 58 (cerium) through 71 (lutetium) on the periodic table. These chemical elements include cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). The lanthanides usually exist as trivalent cations.

Lanthanide ions become luminescent when they have been stimulated or “excited” to do so. This excitation may be achieved for example by passing an electrical current through the material (electroluminescence) or by having it absorb light (photoluminescence). In the case of photoluminescence, light is first absorbed by the material and then subsequently emitted. Usually the absorbed and the emitted light have different colors. The electrical current or absorbed light puts the lanthanide ions in an “excited state.” As the ions relax to their fundamental state (the “ground state”), they emit light.

Lanthanide ions, however, have a poor ability to absorb light. Therefore, it is difficult to generate luminescence by direct excitation of a lanthanide ion. Organic chromophores, which are effective at absorbing light, may be used as antennae for transmitting light to lanthanide ions. The energy absorbed by an organic chromophore is transferred to a nearby lanthanide ion, which is then able to emit its characteristic luminescence. This approach has limitations, however. The dissociation of lanthanide complexes increases as concentration decreases.

### SUMMARY OF THE INVENTION

The present invention relates to compositions of luminescent matter, and methods for making them, in which lanthanide cations are incorporated into semiconductor nanocrystals. The semiconductor nanocrystal structures serve as antennae for allowing the excited electronic states of the semiconductor nanocrystals to sensitize lanthanide cation emission. In comparison to organic antenna types, semiconductor nanocrystals are able to protect lanthanide cations from quenching solvent molecules without supplying high energy vibrations, thereby resisting non-radiative deactivation of the lanthanide cation excited states. Semiconductor nanocrystals such as CdSe have several advantages as species that absorb and emit photons, namely, broad absorbance bands with high epsilon values and emission wavelengths that can be easily tuned through their size, which is controlled through synthesis conditions. Lanthanide cations also have several advantages—sharp emission bands and long luminescence lifetimes. The present invention combines the advantages of both semiconductor nanocrystals and lanthanide cations into a single luminescent nanomaterial.

An aspect of the present invention is to provide a composition of luminescent matter comprising: at least one semiconductor nanocrystal; and at least one lanthanide cation that is incorporated into the semiconductor nanocrystal.

Another aspect of the present invention is to provide a method of forming a composition of luminescent matter, the method comprising: making a stock solution that contains at least one semiconductor anion; introducing at least one semiconductor cation, at least one lanthanide cation, and at least one ligand into a reaction vessel; after the semiconductor cation, lanthanide cation, and ligand are introduced, introducing the stock solution into the reaction vessel to grow crystals of luminescent matter, wherein each crystal of luminescent matter comprises a lanthanide cation that is incorporated into a semiconductor nanocrystal; and purifying the crystals of luminescent matter.

An object of the present invention is to provide a new composition of luminescent matter that exhibits two sources of luminescence: a semiconductor nanocrystal and a lanthanide cation.

Another object of the present invention is to provide a composition of luminescent matter that utilizes semiconductor nanocrystals as antennae for the excitation of lanthanide cation emission.

Yet another object of the present invention is to provide a composition of luminescent matter which has tunable emission and absorbance wavelengths.

A further object of the present invention is to provide greater protection of lanthanide luminescence compared to typical organic-coordinated lanthanide complexes.

Another object of the present invention is to provide a composition of luminescent matter that exhibits high photostability, high thermodynamic stability, sharp emission wavelengths, purity of color, high molar absorptivity, and broad absorption domain.

Yet another object of the present invention is to provide a composition of luminescent matter that has a long luminescent lifetime.

A further object of the present invention is to provide a composition of luminescent matter that can be functionalized, thereby altering the surface of the crystals so that they can be, for example, attached to a protein or other biological species, or some other desired location (surface, specific biological site, etc.).

Another object of the present invention is to provide a composition of luminescent matter that can be functionalized to control solubility in different solvents, add additional chromophoric groups, and increase the stability of the crystals.

Yet another object of the present invention is to provide a composition of luminescent matter that can emit light in visible and near infrared ranges.

A further object of the present invention is to provide methods for preparing compositions of luminescent matter having the characteristics described hereinabove.

These and other objects of the present invention will become more readily apparent from the following detailed description and appended claims.

### FIGURES

FIG. 1 presents a plot of steady state and time-resolved emission and excitation spectra for a sample of purified CdSe:Tb nanocrystals.

FIG. 2 presents a plot of normalized emission spectra of CdSe:Tb nanocrystals in chloroform.

FIG. 3 presents a plot of emission wavelength maximum versus growth time for a batch of CdSe:Tb nanocrystals in chloroform.

FIG. 4 presents a plot of the time-resolved emission intensity of the most intense terbium transition located at 546 nm versus the growth time.

FIG. 5 presents a plot showing the locations of two emission maxima for the different samples of a batch of CdSe:Tb nanocrystals, plotted with respect to growth time.

FIG. 6 presents a plot showing steady state emission spectra of a sample of CdSe:Tb nanocrystals in chloroform (growth time 300 s).

FIG. 7 presents a transmission electron microscopy (TEM) image of CdSe:Tb nanocrystals (60 s growth time), taken at a magnification of 850 K.

FIG. 8 presents a plot that illustrates the results of a qualitative energy dispersive spectroscopy (EDS) experiment performed for a CdSe:Tb nanocrystal sample.

FIG. 9 presents a plot showing terbium luminescence lifetimes measured throughout a stability study.

### DETAILED DESCRIPTION OF THE PREFERRED EMBODIMENTS

As used herein, the term “crystals of luminescent matter” refers to a new composition of luminescent matter in which lanthanide cations are incorporated into semiconductor nanocrystals. The crystals of luminescent matter are also referred to as “nanocrystals” because of their size.

The present invention relates to compositions of luminescent matter in which lanthanide cations are incorporated into semiconductor nanocrystals, and methods for making these compositions. The semiconductor nanocrystal structure serves as an antenna for allowing the excited electronic states of the semiconductor nanocrystals to sensitize lanthanide cation emission. In comparison to organic antenna types, semiconductor nanocrystals are able to protect lanthanide cations from quenching solvent molecules without supplying high energy vibrations, thereby resisting non-radiative deactivation of the lanthanide cation excited states. Semiconductor nanocrystals such as CdSe have several advantages as species that absorb and emit photons, namely, broad absorbance bands with high epsilon values and emission wavelengths that can be easily tuned through their size, which is controlled through synthesis conditions. Lanthanide cations also have several advantages—sharp emission bands and long luminescence lifetimes. The present invention combines the advantages of both semiconductor nanocrystals and lanthanide cations into a single luminescent nanomaterial.

The new compositions of luminescent matter may be utilized in a variety of applications, including but not limited to use as a biological sensor, luminescent probe, protein sensor, DNA sensor, imaging agent (biological, optical/magnetic), and MRI contrast agent. The luminescent matter may also be used for nano-electronics, display technology, nano-LED (light emitting diode), and FRET assay (biological).

The luminescent matter of the present invention is particularly effective because it contains two sources of luminescence: the semiconductor nanocrystal and the lanthanide cation. In addition, the emission and absorbance wavelengths are tunable, and there is greater protection of lanthanide luminescence compared to typical organic-coordinated lanthanide complexes. The luminescent matter also exhibits high photostability, high thermodynamic stability, sharp emission wavelengths, purity of color, high molar absorptivity, and broad absorption domain. The luminescent matter can be functionalized, and it can emit light in visible and near infrared (NIR) ranges. By creating crystals of luminescent matter with different unique combinations of luminescent species, and then attaching them to different types of protein or other biological species, it is possible to separate them by their specific and independent signals known as “barcode.” Compared to currently available technology, the luminescent matter of the present invention provides lanthanide emission wavelengths that are independent from experimental conditions, suitable for multiplex assay, and suitable for time-resolved measurements due to the removal of autofluorescence.

Any suitable semiconductor material may be used, including but not limited to CdSe, CdTe, CdS, ZnS, ZnSe, TiO₂, SiO₂, and PbSe. The semiconductor material includes a cation component and an anion component. For example, if the semiconductor material is CdSe, Cd represents the semiconductor cation and Se represents the semiconductor anion.

The lanthanide cation may be comprised of any suitable chemical element or combination of elements in the lanthanide series. This series includes cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). In a preferred embodiment, the lanthanide cation is terbium. Samarium, europium, and dysprosium may be used to emit light in the visible range. Neodymium, holmium, erbium, thulium, and ytterbium may be used to emit light in the near infrared (NIR) range. Gadolinium may be used to emit light in the ultraviolet range or for magnetic purposes (such as MRI contrast agents).

The new composition of luminescent matter may be created by incorporating at least one lanthanide cation into at least one semiconductor nanocrystal. The lanthanide cation is said to be “incorporated” into the semiconductor nanocrystal when the lanthanide cation is attached or bound to the semiconductor nanocrystal so that the semiconductor may serve as an antenna for the excitation of lanthanide cation emission. The lanthanide cation may at least partially cover the structural surfaces of the semiconductor nanocrystal, or at least partially infiltrate its crystal lattice structure. However, the present invention is not limited to any particular theory of attachment or incorporation for the lanthanide cation.

Although the present invention is not limited to any particular methodology, in a preferred embodiment, the new composition of luminescent matter may be prepared using the following steps: 1) making a stock solution that contains at least one semiconductor anion, 2) introducing at least one semiconductor cation, at least one lanthanide cation, and at least one ligand into a reaction vessel, 3) after the semiconductor cation, lanthanide cation, and ligand are introduced, introducing the stock solution into the reaction vessel to grow crystals of luminescent matter, wherein each crystal of luminescent matter comprises a lanthanide cation that is incorporated into a semiconductor nanocrystal, and 5) purifying the crystals of luminescent matter. This methodology is described in more detail below. While the description contained herein primarily refers to the use of one semiconductor anion, one semiconductor cation, one lanthanide cation, and one ligand, it is understood that more than one type of semiconductor material, and therefore more than one semiconductor anion and semiconductor cation, may be used. In addition, more than one type of lanthanide cation and more than one ligand may be used.

In a preferred embodiment, a stock solution is made, which contains the metallic form of a semiconductor anion (e.g., Se or Te). The semiconductor anion may be provided in powder form and may be dissolved in a suitable solvent such as trioctylphosphine (TOP) and anhydrous toluene. The solution may be stirred, gently heated, sonicated, or otherwise treated until the anion powder is fully suspended in the solvent mix. The Schlenk technique of freezing under nitrogen gas and thawing under vacuum may be used to remove any unwanted oxygen gas or water from the solution. The stock solution is then stored under nitrogen for later use in the process.

A semiconductor cation (e.g., Cd or Zn) and a lanthanide cation may be provided in a salt or complex form. For example, in a preferred embodiment the semiconductor cation may be provided as CdO, and the lanthanide cation may be provided as Tb(NO₃)₃. Other suitable complexes include diethyl zinc and cadmium perchlorate for the semiconductor cation, and lanthanide perchlorate, lanthanide citrate, and lanthanide acetate for the lanthanide cation. The type of complex used will vary depending on its stability and strength of bonding. For example, TbO is extremely stable, whereas CdO is less stable and will therefore dissociate into solution more easily to form nanocrystals. Tb(NO₃)₃ is another complex that contains weak bonds, allowing it to dissociate into solution more easily to form nanocrystals.

The semiconductor cation and lanthanide complexes are weighed to achieve the desired amount of lanthanide, which may range from about 0.001 to 90 percent of the total amount of semiconductor cation and lanthanide complexes. For CdSe:Tb, the desired amount of lanthanide may range from about 5 to 18 percent of the total amount of semiconductor cation and lanthanide complexes. The complexes may be placed in a reaction vessel with a ligand, such as n-tetradecylphosphonic acid (TDPA), hexadecylamine (HDA), or any other suitable coordinating ligand, which facilitates the growth of nanocrystals and helps control the rate at which growth occurs. The ligand may be provided in a quantity that ranges from about 50 to 500 percent of the amount of semiconductor cation present. In a preferred embodiment, the quantity of ligand is about 200 percent the amount of semiconductor cation present. A suitable solvent, such as trioctylphosphine oxide (TOPO), may also be introduced into the reaction vessel. While the present invention is not limited to any particular amount of solvent, the solvent may be introduced in an amount that ranges from about 5 to 20 times the total amount of semiconductor cation and ligand provided. In one embodiment, the solvent may be introduced in an amount that is about 10 times the total amount of semiconductor cation and ligand provided.

The reaction vessel may be sealed and placed under argon gas, or an alternative inert gas. The solution is stirred and heated to a temperature that allows the cation and lanthanide complexes to dissociate into solution. This temperature may vary depending on the type of semiconductor material. For CdSe:Tb, the temperature may range from about 200-360 degrees Celsius in a preferred embodiment. Once dissociation has occurred, the temperature in the reaction mixture is adjusted to an “optimal temperature” that supports steady crystal growth. This optimal temperature varies for different types of semiconductor materials and lanthanides, and is determined through experimentation. The optimal temperature for growth of CdSe:Tb typically ranges from about 220 to 280 degrees Celsius.

While stirring, under inert gas flow, the stock solution may be introduced or injected into the reaction vessel. At this point, the semiconductor anions and cations combine with the lanthanide cations and ligands to form crystals of luminescent matter, i.e., semiconductor nanocrystals that incorporate lanthanide cations. Aliquots of this composition may be removed from the reaction vessel at varying times depending on the amount of growth that is desired and the type of semiconductor material and lanthanide employed. Although the present invention is not limited to any particular duration of time, the growth period may range from a few seconds to days. The growth period will be shorter for small crystals with high energy emission/absorption range values. In one embodiment, the growth period for CdSe:Tb may range from about 15 to 120 seconds. Since the accepting energy levels of different lanthanide cations fall at different locations, the ideal energy range for the crystals, and thus size and growth time, will vary.

Once the aliquots are removed, the composition may be purified to remove unwanted reaction by-products and unused reactants. The composition may be dispersed in a solvent, such as methanol, in which it is not soluble, and subject to centrifuge. The precipitate is then dissolved in an organic solvent in which the crystals of the composition are soluble, such as chloroform or hexane. The composition may be subjected to another round of centrifuge to provide additional removal of unwanted reaction by-products. The centrifuge step may be repeated as often as desired. The supernatant from the centrifuge step(s) contains the final, prepared crystals of luminescent matter in which semiconductor nanocrystals are incorporated with lanthanide cations.

The molar ratio of semiconductor material to lanthanide in the new luminescent matter may vary considerably. In a preferred embodiment for CdSe:Tb, the molar ratio may range from about 80:20 to about 90:10. The size or average width of the crystals of luminescent matter will vary depending on the type of semiconductor material and lanthanide cation that are employed, but is usually less than 100 nanometers. In a preferred embodiment, the size of the crystals ranges from about 2 to 20 nanometers, excluding any coating that is provided on the crystals. The size of the crystals may be controlled through the length of growth time during synthesis.

The emission wavelength of the semiconductor nanocrystal will vary from ultraviolet to near infrared depending on the type of semiconductor material used and the size of the nanocrystal. For CdSe, the emission wavelength may range from about 350 to 750 nanometers. The epsilon value for the semiconductor nanocrystal may range from about 10⁴ to 10⁶, and is preferably about 400,000.

The emission wavelength of the lanthanide cation will vary depending on the type of lanthanide cation used and the size of the crystals of luminescent matter. The emission wavelength of a lanthanide cation typically ranges from about 415 to 1600 nanometers. The luminescence lifetime of the lanthanide cation may range from about 2 to 3 milliseconds, although the present invention is not limited to any particular luminescence lifetime.

### EXAMPLE

Reagents

The following reagents were employed: Trioctylphosphine oxide [TOPO] (99%), Trioctylphosphine [TOP] (90%), Cadmium Oxide (99.99% puratrem), Selenium Powder (99.99%), n-tetradecylphosphonic acid [TDPA] (98%), Hexadecylamine [HDA], Terbium Nitrate hexa-hydrate (99.998%), anhydrous toluene, and Argon gas. All chemicals were used without purification except toluene, which was distilled prior to use.

Synthesis

Selenium stock solutions were prepared as follows: 1 mmol of selenium powder was dissolved in 4 mL of TOP and 0.1 mL of toluene through vigorous stirring in a schlenk tube. Excess air was removed through schlenk techniques under a nitrogen atmosphere. The solution was stored under nitrogen until used.

To synthesize the nanocrystals, the following procedures were followed; the same basic procedure was used in all cases with some different variations. Many batches were made and analyzed, all resulting in a product with consistent properties. For batches where TDPA was used as the ligand, 10.0 mmol of TOPO, 0.33 mmol of CdO, 0.07 mmol of Tb(NO₂)₃.6H₂O, and 0.80 mmol of TDPA were used, corresponding to 12% doping with terbium. Batches were also made using HDA as the ligand, and there were two different terbium doping levels. For doping at 12%, 0.80 mmol of HDA was used with the same amounts of all other reagents with TDPA as the ligand. For 10% doping, 10.0 mmol of TOPO, 0.36 mmol of CdO, 0.04 mmol of Tb(NO₂)₃.6H₂O, and 0.80 mmol of HDA were used. All starting reagents were placed together in the reaction vessel, a three-neck 50 mL round bottom flask. The flask necks were fitted with water condensers. Contents were placed under argon and heated to 300° C., using a heating mantle connected to a variable autotransformer for temperature control. Selenium stock solution was injected at 300° C., and the temperature was reduced to 250° C. for the duration of nanocrystal growth. In some cases, the synthesis was carried out at slightly lower temperatures of injection at 250° C. followed by growth at 230° C. Aliquots were removed at a variety of times ranging from seconds to hours after injection using a syringe. For purification, samples were dissolved in chloroform then purified through centrifugation and precipitation in methanol. It was possible to transfer purified nanocrystals into hexane and toluene, as well as chloroform. However, most analytical studies of the nanocrystals were completed using chloroform.

Instrumental

Absorption spectra were recorded on a Perkin-Elmer Lambda 9 BX Spectrometer coupled with a personal computer using software supplied by Perkin-Elmer. Time resolved and steady state luminescence spectra and excitation spectra were recorded with a Cary Eclipse coupled to a personal computer using software supplied by Varian or a modified Jobin-Yvon Spex Fluorolog-322 spectrofluorimeter. Chloroform-resistant well plates were machined out of high-density black polyethylene, which allowed for a quick analysis of the different samples of batches of nanocrystals with the well-plate adapter on the Cary Eclipse. This insured consistent instrumental settings while studying the changes in photophysical properties with size (growth time) of a batch of nanocrystals.

Steady state luminescence quantum yields were measured using quinine sulfate (Φ=0.546) solutions as the reference. Emission spectra were collected using a Jobin-Yvon Spex Fluorolog-322 spectrofluorimeter and spectra were corrected for the instrumental function. The quantum yields were calculated using the following equation:
Φₓ/Φᵣ=[Aᵣ(λᵣ)/Aₓ(λₓ)][I(λᵣ)/I(λₓ)][ηₓ²/ηᵣ²][Dₓ/Dᵣ] (2)
where subscript r stands for the reference and x for the sample; A is the absorbance at the excitation wavelength, I is the intensity of the excitation light at the same wavelength, η is the refractive index (η=1.333 in H₂O, η=1.4458 in chloroform) and D is the measured integrated luminescence intensity.

Time resolved luminescence quantum yields were measured using Tb(H22IAM) reference solutions in methanol, which has a known quantum yield of 0.59. Luminescence lifetime decays were collected for both the nanocrystals and the reference solutions with an excitation wavelength of 350 nm, along with time-resolved emission spectra. The time-resolved emission spectra were collected with a delay time of 0.1 ms using the phosphorimeter module of the Jobin-Yvon Spex Fluorolog-322. The exponential decays were integrated from 0 to 25 ms and from the delay time to 25 ms. The 25 ms value was chosen because it is a point long past any remaining luminescence for either Tb³⁺ complex. The differences in these two integrated values were used to determine the amount of luminescence intensity lost to the time-delayed measurement, using the following equation:
I₀=[I*×A₀]/A* (3)
where A* is the area under the lifetime curve from the delay time to 25 ms, A₀ is the area from time zero, I* is the integrated intensity measured after the delay, and I₀ is the calculated total intensity. Once the intensities have been calculated, the quantum yield of the sample can be calculated through the following equation:
φ_{S}=φ_{ref}[Iₛ/I_{ref}][Aₛ/A_{ref}][η_{S}/η_{ref}] (4)
where φ_{S} and φ_{ref} are the quantum yields of the sample and reference respectively, I is the calculated intensity, A is the absorbance value, and η is the refractive index of the solvent (chloroform=1.443, methanol=1.326).

The lifetime measurements were performed by excitation of solutions in 1 mm quartz cuvettes using a xenon flash lamp. Emission was collected at a right angle to the excitation beam, and wavelengths were selected by means of the Jobin-Yvon Spex Fluorolog-322 FL1005 double monochromator. The signal was monitored by a Hamamatsu R928 photomultiplier coupled to a 500 MHz bandpass digital oscilloscope. The signal from >200 flashes was collected and averaged. Lifetimes were averaged over samples from several different batches. Lifetimes were also collected using the software provided with the Jobin-Yvon Spex Fluorolog-322.

Stability Study

A month long stability study was performed on the CdSe:Tb nanocrystals. A sample of nanocrystals was collected after 15 seconds of growth time, and half the sample was kept in its raw form and the other half of the sample was purified. Both the purified and raw samples were studied, so that a comparison could be made between the two. In order to account for instrumental variations, standards were tested along side the nanocrystals. A 10⁻⁵M Tb(H22IAM) solution in methanol was used as the standard for comparison for Tb³⁺ luminescence lifetime measurements and time-resolved excitation and emission measurements. A quinine sulfate solution was used for comparison with steady state emission measurements.

For the study, measurements were taken every day for the first two weeks, then every other day for the remainder of the month. All measurements were collected with the Jobin-Yvon Spex Fluorolog-322 spectrofluorimeter. Time resolved excitation spectra were collected for pure and raw samples, with the following parameters: λₑₘ 545nm, λₑₓ 200-500 nm, delay 0.2 ms, 1 nm increments, sample window 20 ms, time per flash 50 ms, 2 flashes, emission and excitation slits at 10 nm. Time resolved emission spectra were collected with the following parameters: λₑₓ 230 nm and 270 nm, λₑₘ 400-800 nm, delay 0.2 ms, 1 nm increments, sample window 20 ms, time per flash 50 ms, 2 flashes, emission and excitation slits at 10 nm. The following parameters were used for steady state emission spectra, collected for both pure and raw samples: λₑₓ 300 nm, λₑₘ 320-800 nm, 1 nm increments, emission and excitation slits at 2.5 nm. Two sets of lifetime measurements were collected for both raw and pure samples, one set where the Tb³⁺ was excited directly with λₑₓ 230 nm, and a second set where excitation was through the nanocrystals, λₑₓ 270 nm. In all cases, slits of 10 nm were used for both excitation and emission, and measurements were collected with the Jobin-Yvon Spex Fluorolog-322 program and acquisition electronics for lifetime measurements. All results were normalized with respect to the standard measurements.

TEM Imaging

For obtaining TEM images, Ted Pella 300 mesh Copper Grids with 50 angstrom carbon coating were used as the support. A batch of quantum dots was synthesized at 10% doping with Tb³⁺, grown at 230° C., and samples were collected at 15, 30, 60 and 120 seconds after injection. The first attempt at obtaining TEM images was done with the raw samples dissolved in chloroform. Samples were prepared by placing a drop of solution on the grid and allowing the solvent to evaporate. The grids appeared highly disarrayed, which indicated that the nanocrystal solutions contained a lot of impurities. The nanocrystals were purified through centrifugation with methanol, dissolved in chloroform, and new samples were prepared. Upon examination under the microscope, these samples appeared to have lost most of the carbon coating off the grids, although in a few areas some blurry images were obtained. The loss of the carbon coating may have been due to chloroform dissolving the surface, so the nanocrystals were transferred into hexane. There was less carbon degradation, but clear images were still not obtained. This TEM instrument was operated at 80 kV, which is a low resolving power compared those reported with most published TEM images of nanocrystals where 200 or 300 kV voltage was typical.

Another attempt at obtaining TEM images of the CdSe:Tb nanocrystals was made using a JEOL 1210 TEM, which can operate at 120 kV. The nanocrystals were used in their purified form, dissolved in chloroform. For sample prep, the grids were dipped into a solution of the nanocrystals and allowed to dry. This time, it was possible to get images of the nanocrystals, although they were fairly blurry due to the limited resolution of the instrument. They did, however, give an indication of the size of the nanocrystals, samples collected at growth times of 15 and 120 seconds were both approximately 2 nm in size. This is the typical range of size for CdSe nanocrystals. The mono-dispersity of the samples at this range was difficult to determine due to cloudiness of the image. While it was possible to see the nanocrystals, the edges were poorly defined, so it was difficult to determine exact sizes.

In the third and most successful attempt, TEM images were obtained with a JEOL 2000-FX Scanning Transmission Electron Microscope. The TEM operated at up to 200 kV, providing a much brighter and clearer image. The sample grids were prepared with purified nanocrystals dissolved in hexane. The nanocrystal solution was aspirated onto the grids with an atomizer, as follows: the grid was held by a pair of the jewelers tweezers, and then secured to a ring stand in the hood, with the darker side of the grid facing out to insure the solutions are put on the side with the carbon coating, the nanocrystal solution was put in a capillary tube, which was put into a holder at the top of an air canister, and then sprayed onto the grid. This type of sample preparation tends to provide even distribution of the nanocrystals on the grid surface. The samples were allowed to dry for a few minutes and then examined under the microscope.

The nanocrystal sample collected after 120 seconds was the first to be examined and several difficulties were noted. First, severe darkening of the sample was occurring where the electron beam was hitting the sample, which was likely due to the migration of hydrocarbons present from the hexane solvent. In the direct path of the electron beam, the hydrocarbons will heat up, and start moving. Once they hit the edge of the beam the temperature decreases, thus causing them to cease migration. This led to dark circles that made it almost impossible to look for images of the nanocrystals. To address this problem, future samples were prepared several hours ahead and exposed to a halogen light to help evaporate off all the hexane. An additional problem was that microscope needed to be calibrated in order to achieve the desired magnification. With all of this considered, another grid was prepared with the nanocrystal sample collected at 15 seconds and the microscope was calibrated. The acceleration voltage was 200 KV and the magnifications were up to 850,000×. Photographed images were obtained in TEM mode using a Gatan CCD camera and Gatan software. These results proved to be much more promising. The dark circles were still observed, but it was possible to work around them as they appeared more slowly in this case. The calibration allowed for going to higher magnifications, and it was possible to detect smaller dots on the surface. A TEM of an empty background section was taken for comparison. There was a definite difference between the blank area and the area containing the nanocrystal sample. While the nanocrystals did not produce extremely dark images, they were still clearly visible. They appeared to be comprised in a range of 2-4 nanometers in size, based on a size bar. However, precise measurements were not possible because the imaging software used with this instrument did not have a point to point measurement tool.

EDS

EDS (Energy Dispersive X-Ray Spectroscopy) was done of some of the areas where images were collected. The measurements done at this time were qualitative only. The results indicated the presence of Cd, Se, and Tb on the sample grid.

Results and Discussion

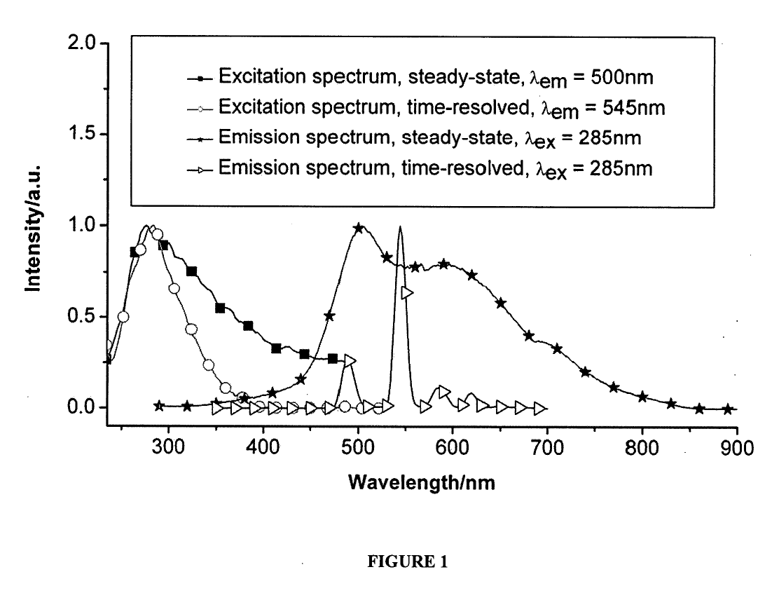

Cadmium selenide nanocrystals incorporated with terbium have been synthesized and energy transfer to terbium through the nanocrystal electronic structure has been demonstrated through emission and excitation spectra of these novel types of nanocrystals. When measurements were collected in steady state mode, only the overall broad emission arising from the nanocrystal electronic structure was detected. When a time-resolved excitation spectrum was collected on the emission at 545 nm, the main peak for Tb³⁺, two maxima were detected. The first was located at 220 nm, which corresponds to an allowed d-f transition. The second maxima at 284 nm correlated perfectly in shape and location to the excitation spectra for nanocrystal emission. Time-resolved emission spectra using both these wavelengths for excitation produced a characteristic terbium emission spectrum. The results of this luminescence analysis are illustrated in FIG. 1. Terbium emission is discriminated from nanocrystal emission through time-resolved measurements. The ability to sensitize terbium emission through the nanocrystal electronic structure was crucial, as it provided proof of the concept that nanocrystals could serve as antennae for lanthanide cations.

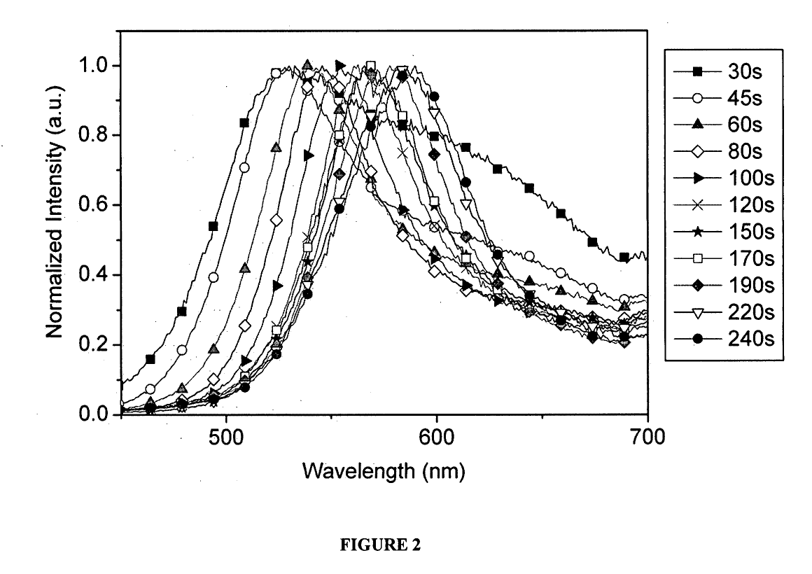

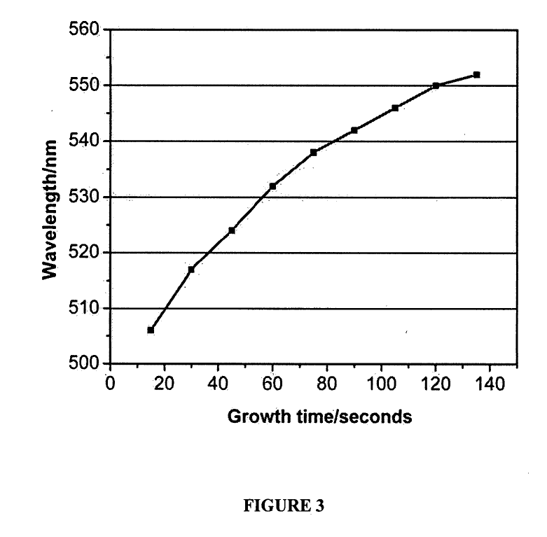

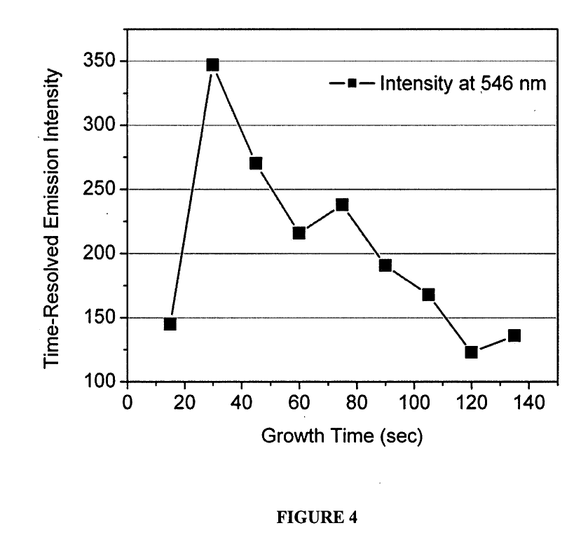

The red-shift in absorption and emission energies of the nanocrystals with increasing size could be observed by the human eye. The size of the nanocrystals was controlled through the length of growth time during synthesis. It was also important to have a quantitative instrumental method that could monitor the change in size throughout different samples of a single batch of nanocrystals. Collecting emission and excitation spectra of the different samples for a batch of nanocrystals allowed a relative comparison of emission wavelength verse growth time to be determined. The Cary Eclipse fluorimeter is equipped with a plate-reader, which was extremely helpful for this type of analysis, as it enabled a systematic comparison and rapid evaluation. It has been possible to monitor the respective position of the fluorescence maximum of the nanocrystals in relation to growth time through their emission spectra. In FIG. 2 the steady state emission spectra for the different samples of a batch of CdSe:Tb nanocrystals are shown, illustrating the shift to lower energies as size increases for longer growth times. The results for one batch of CdSe:Tb nanocrystals are shown in terms of the correlation between the emission maximum wavelength and growth time for each sample are shown in FIG. 3. The steady rate at which emission wavelength maxima shift to lower energies with increased growth time confirms that the synthetic route provided control over the emission energy of the nanocrystals. Time-resolved measurements could also be collected with this setup, which allowed terbium emission to be discriminated from the nanocrystal emission. Therefore, with the same instrument and sample set up, it was possible to determine the relative extent of lanthanide sensitization in each different growth time/nanocrystal size. Using this quick screening method, the ideal growth times for CdSe:Tb nanocrystals, in terms of producing the most intense terbium emission, were determined to be comprised between 15 and 60 seconds, with a maximum around 30 seconds, see FIG. 4. Based on results from TEM measurements, which are discussed further below, and emission spectra, this growth time correlates with nanocrystals that are about 2 nm in diameter and have emission energy maxima around 20,000 cm⁻¹. The lowest excited state of Tb^{3+, the} ⁵D₄ transition, is located at 20,545 cm⁻¹. The energies of the donating levels of the nanocrystal and the accepting level of Tb³⁺ are very close in value. The nanocrystal sample contains a distribution of nanocrystal sizes, so it might be that only the smaller nanocrystals in the sample, those with higher emissive energies (400-475 nm), are actually sensitizing terbium. To obtain solutions of doped nanocrystals with ideal levels of Tb³⁺ sensitization, more narrow size distribution would be ideal.

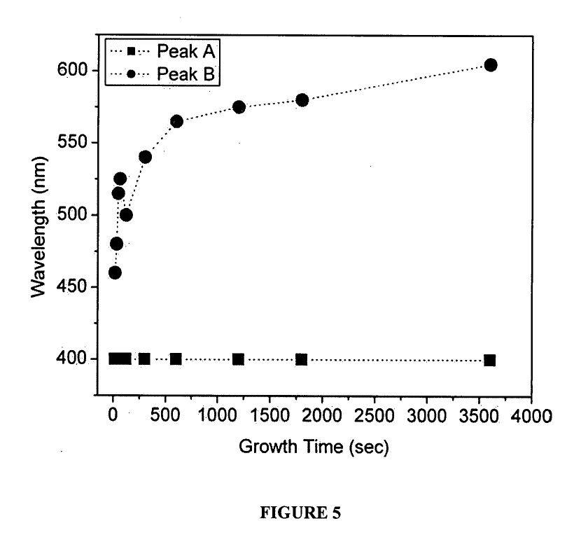

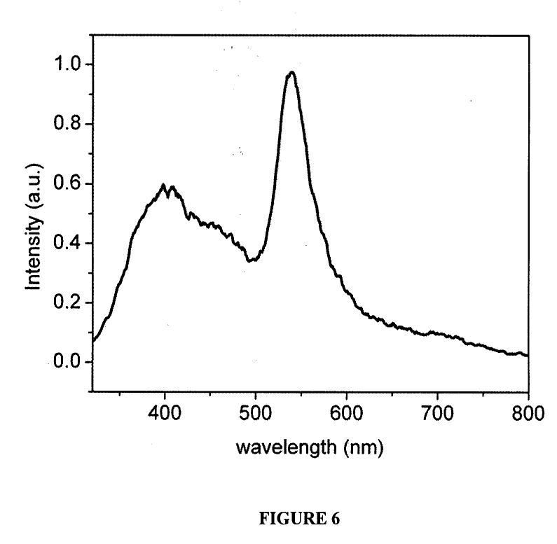

For a batch of CdSe:Tb nanocrystals that were prepared with 10% doping, HDA as the ligand, and synthesis temperatures of 250° C. and 230° C., the results are illustrated in FIG. 5. The steady state emission spectra of the different samples all displayed two maxima. There was a higher broader energy band located at 400 nm that was present for all samples. In addition, there was a lower energy band that shifted to higher wavelengths (450-600 nm) as growth time increased. The appearance of these two bands may be tentatively explained by the existence of two types of emissive energy states in the nanocrystals. The emission at 400 nm, which did not shift in energy with growth time, could be due to surface trap energy states, which are independent of nanocrystal size. The maximum that shifts to lower energies is likely due to the quantum confined exciton energy states, which would depend on the size of the nanocrystal. The lower energy peaks are also sharper, see FIG. 6 for an example, which may be due to better protection from broadening due to solvent interactions than the surface energy states.

For a more quantitative analysis of the nanocrystals the Jobin Yvon Spex Fluorolog-322 spectrofluorimeter, which has a photon-counting detection unit, was used. It is equipped for both room temperature and low temperature measurements. Quantum yield measurements were performed with this instrument, which had also been fitted with a homemade quantum yield automatic sample holder and corresponding software to facilitate the ease and accuracy of making these measurements. The quantum yield apparatus allowed for simple data collection, despite the different excitation wavelengths for the samples and the reference. The quantum yield measured of the total nanocrystal emission of a sample of CdSe:Tb nanocrystals in chloroform (10% doping, HDA ligand, 250° C./230° C., 15 s growth time) at room temperature was 2.90% (+/−0.25%). The measured quantum yield for the terbium emission of the same sample was roughly 0.02%. Low quantum yields are typical for uncoated nanocrystals, coating the CdSe nanocrystals with a thin layer of another semiconductor, such as ZnS, has been shown to increase quantum yields.

Luminescence lifetime measurements were also collected with this instrument. Alternatively, measurements were done by coupling a Hamamatsu-R316 cooled photomultiplier detector to a Tektronics TDS 754D digital oscilloscope. Measured luminescence lifetimes of the terbium emission were in the range of 2-3 ms (unpurified nanocrystals, excited directly: 2.85 ms +/−0.15 ms, excited through the nanocrystals: 2.75 ms+/−0.20 ms; purified nanocrystals excited directly: 2.35 ms+/−0.20 ms, excited through the nanocrystals: 2.25 ms+/−0.15 ms). These values are relatively long with respect to those reported in literature for terbium complexes formed with organic ligands, which indicates that good protection of the lanthanide cation was obtained through the incorporation into nanocrystals. Luminescence lifetime values are often short due to deactivation through non-radiative transitions from OH, NH, and CH oscillators. Since these types of oscillators are not present in the CdSe nanocrystals, longer lifetimes are possible.

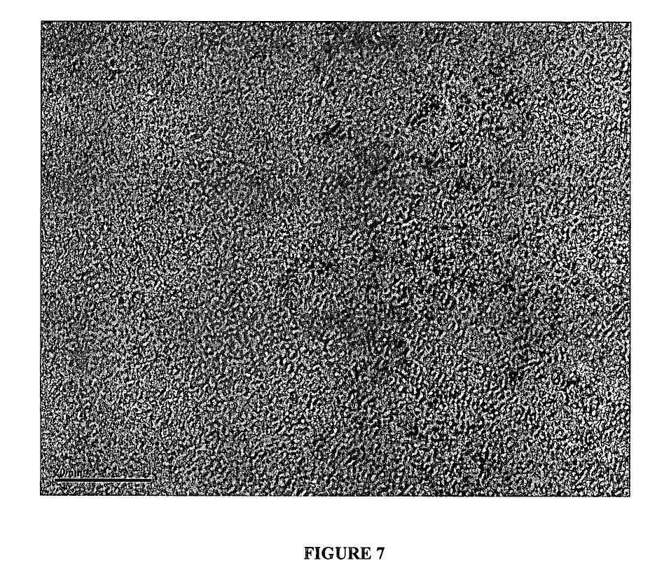

The size and shape of the nanocrystals were evaluated with transmission electron microscopy (TEM). The TEM image shown in FIG. 7 was obtained with a JEOL 2000-FX scanning transmission electron microscope operated at a magnification of 850K. This is the image of a sample prepared with 10% terbium doping, HDA as the ligand, and 60 s growth time. It was purified through centrifugation in methanol, dissolved in hexane, and aerated onto a carbon-coated 200 mesh copper grid for the image. These nanocrystals were uncoated, so it was possible to gauge their actual size. An analysis of the size distribution revealed the nanocrystals range between 2-3 nm. Uncoated nanocrystals often aggregate together, as seen in this image. The image does appear to be slightly blurry, which makes an exact determination of the size difficult. Most TEM images of CdSe nanocrystals appear slightly blurry, due to the large lattice structure (long spacings) and the very small size of the nanocrystals (a few nanometers). At this size range, the orientation of the crystals in the electron beam becomes very important. If the Bragg angle is optimal, a clearer image, even one with visible crystalline structure, is possible. However, whenever the angle diverges, a much dimmer image results. In fact, it could be possible for the electron beam to pass through without resulting in an image. This phenomenon results from the proportionality of elastic versus inelastic scattering that occurs when the electron beam passes through the sample. If the beam bounces off the sides of the nanocrystal or passes through the crystal spacing unperturbed, a much weaker signal results compared to when the electrons are absorbed by the nanocrystals. Therefore, despite the fact that this TEM image may seem a little blurry it is actually quality data and provides substantial information.

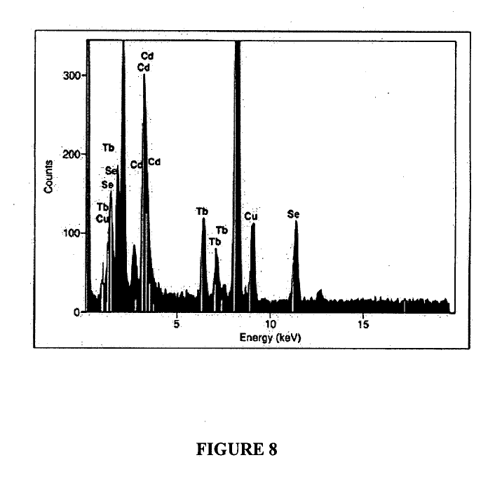

The nanocrystal sample that is shown in FIG. 7 was also analyzed with energy dispersive spectroscopy (EDS). The results from this analysis are shown in FIG. 8, and provide proof that the nanocrystal samples contain Cd, Se, and Tb. Although the results shown here are qualitative, the presence of Th in the nanocrystals confirms that the synthesis method used here successfully incorporated the lanthanide cation. Further experiments would be necessary to determine the actual location of the lanthanide cation within the CdSe:Tb crystal.

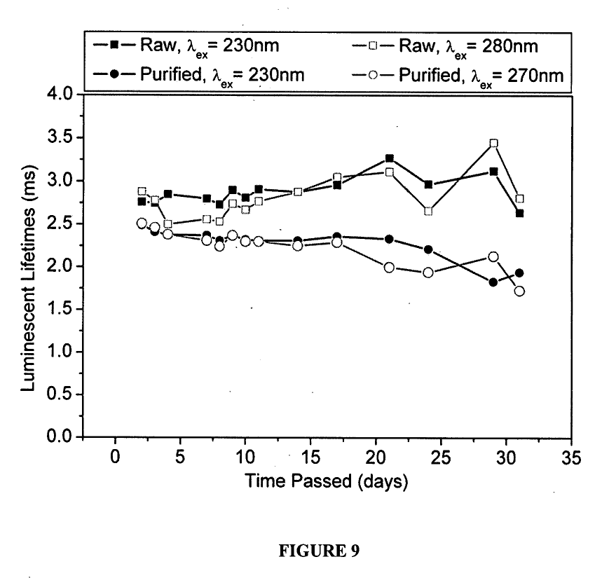

The data collected throughout the study demonstrated qualitatively that the photophysical properties of the CdSe:Tb nanocrystals remained relatively unchanged over the course of one month. In this study, the nanocrystal samples were removed from their container, placed in a cuvette for measurements and then returned to their containers every day that measurements were made. During this process solvent was lost to evaporation, which constantly modified the concentration of the samples. This also allowed for extended exposure to oxygen, which could have induced some decomposition. These factors led to variations in the emission intensities that rendered the data of measurements done over time to be difficult to interpret. Emission intensities appeared to increase, but this was likely due to an increase in concentration rather than any stability effects. Over the course of the month long study, there was never a loss of general nanocrystal or terbium emission, which does confirm the stability. Luminescence lifetime values are independent of concentration, so these measurements have been unaffected by the loss of solvent; although they may have been affected by exposure to oxygen. However, the results for this study were also inconclusive, as the data collected for the reference produced sporadic values (refer to FIG. 9). The luminescence lifetimes for the nanocrystals did appear to remain fairly constant, but the reference values did not, jumping between values of ˜2.2 and ˜1.4 ms (see FIG. 9), so any drawn conclusions cannot be verified. Disregarding the inconsistency in the reference measurements, the results seem to indicate that the raw nanocrystals have longer lifetimes than the purified ones and they maintain these values better over time. The protective coating provided by TOPO on the nanocrystals may have been partially removed during purification, which possibly led to a slightly lower stability over time.

Conclusions

The experiment shows that using semi-conductor nanocrystals as antennae for lanthanides provides new materials with remarkable luminescent properties. Evidence of energy transfer from the electronic structure of the nanocrystal to the lanthanide cation has been demonstrated. Excitation through the nanocrystals and directly on the lanthanide cation both produced luminescent lifetimes that are long in comparison to Ln(III) complexes formed with organic ligands, on the order of 2 to 3 ms. These lifetime values support the idea that the nanocrystal structure provides efficient protection from solvent molecules without providing any route for quenching mechanisms. Results from energy dispersive spectroscopy confirmed the presence of terbium in the CdSe nanocrystals. TEM data have confirmed that the size of the nanocrystals capable of transferring energy to terbium are in the range of 2-4 nm. The results of the stability study indicated that the raw nanocrystals were resistant to photobleaching and decomposition over at least a month long period.

Initially, it was thought that surface-plasmon resonance, which is a concern whenever a semiconductor is placed in close proximity to an emitting species, may prevent the nanocrystals from serving as an antenna for the lanthanide cation. The evidence of long-lived terbium emission that was sensitized through the nanocrystals indicates that while surface plasmon resonance may exist, it does totally inhibit energy transfer. Since both the terbium and nanocrystal emission can be detected and the emission of the terbium is easily discriminated through time resolved measurements, this species has at least a double signal signature. This is a great property for a biodetection agent where a doubly verified signal is important to identify a positive or negative result.

It will be appreciated that the present invention provides new compositions of luminescent matter, and methods for making them, in which lanthanide cations are incorporated into semiconductor nanocrystals. The semiconductor nanocrystal structures serve as antennae for allowing the excited electronic states of the semiconductor nanocrystals to sensitize lanthanide cation emission.

Whereas particular embodiments of this invention have been described above for purposes of illustration, it will be evident to those skilled in the art that numerous variations of the details of the present invention may be made without departing from the invention as defined in the appended claims.

What is claimed is:

1. A composition of luminescent matter comprising:
at least one semiconductor nanocrystal; and
at least one lanthanide cation that is incorporated into the semiconductor nanocrystal.

2. The composition of claim 1, wherein the semiconductor nanocrystal comprises a material selected from the group consisting of CdSe, CdTe, CdS, ZnS, ZnSe, TiO₂, SiO₂, and PbSe.

3. The composition of claim 1, wherein the lanthanide cation is terbium.

4. The composition of claim 1, wherein the lanthanide cation is selected from the group consisting of cerium, praseodymium, neodymium, promethium, samarium, europium, gadolinium, terbium, dysprosium, holmium, erbium, thulium, ytterbium, lutetium, and combinations thereof.

5. The composition of claim 1, wherein the semiconductor nanocrystal serves as an antenna for excitation of the lanthanide cation.

6. The composition of claim 1, wherein the semiconductor nanocrystal mitigates non-radiative deactivation of excited states of the lanthanide cation.

7. The composition of claim 1, wherein the lanthanide cation is incorporated into the semiconductor nanocrystal by at least partially covering a surface of the semiconductor nanocrystal.

8. The composition of claim 1, wherein the lanthanide cation is incorporated into the semiconductor nanocrystal by at least partially infiltrating a crystal lattice structure of the semiconductor nanocrystal.

9. The composition of claim 1, wherein both the semiconductor nanocrystal and the lanthanide cation exhibit luminescence.

10. The composition of claim 1, wherein the semiconductor nanocrystal has a size of less than about 100 nm.

11. The composition of claim 1, wherein the semiconductor nanocrystal has a size that ranges from about 2 to 20 microns.

12. The composition of claim 1, wherein the molar ratio of semiconductor material to lanthanide cation ranges from about 80:20 to 90:10.

13. The composition of claim 1, wherein the lanthanide cation has a luminescence lifetime that ranges from about 2 to 3 ms.

14. A method of forming a composition of luminescent matter, the method comprising
making a stock solution that contains at least one semiconductor anion;
introducing at least one semiconductor cation, at least one lanthanide cation, and at least one ligand into a reaction vessel;
after the semiconductor cation, lanthanide cation, and ligand are introduced, introducing the stock solution into the reaction vessel to grow crystals of luminescent matter, wherein each crystal of luminescent matter comprises a lanthanide cation that is incorporated into a semiconductor nanocrystal; and
purifying the crystals of luminescent matter.

15. The method of claim 14, wherein the semiconductor anion is selected from the group consisting of Se, Te, S, and O₂.

16. The method of claim 14, wherein the semiconductor cation is selected from the group consisting of Cd, Zn, Ti, Si, and Pb.

17. The method of claim 14, wherein the lanthanide cation is terbium.

18. The method of claim 14, wherein the lanthanide cation is selected from the group consisting of cerium, praseodymium, neodymium, promethium, samarium, europium, gadolinium, terbium, dysprosium, holmium, erbium, thulium, ytterbium, lutetium, and combinations thereof.

19. The method of claim 14, wherein the semiconductor anion is provided in powder form.

20. The method of claim 14, wherein a solvent is introduced into the stock solution.

21. The method of claim 20, wherein the solvent includes trioctylphosphine and anhydrous toluene.

22. The method of claim 14, wherein the semiconductor cation is provided in complex form.

23. The method of claim 14, wherein the semiconductor cation is provided as CdO.

24. The method of claim 14, wherein the lanthanide cation is provided in complex form.

25. The method of claim 14, wherein the lanthanide cation is provided as Tb(NO₃)₃−.

26. The method of claim 14, wherein the lanthanide cation comprises about 0.001 to 90 percent of total semiconductor cation and lanthanide cation provided.

27. The method of claim 14, wherein the lanthanide cation comprises about 5 to 18 percent of total semiconductor cation and lanthanide cation provided.

28. The method of claim 14, wherein the ligand comprises a compound selected from the group consisting of n-tetradecylphosphonic acid and hexadecylamine.

29. The method of claim 14, further comprising introducing a solvent into the reaction vessel along with the semiconductor cation, the lanthanide cation, and the ligand.

30. The method of claim 29, wherein the solvent comprises trioctylphosphine oxide.

31. The method of claim 14, further comprising adjusting the reaction vessel to an optimal temperature that supports crystal growth prior to introducing the stock solution.

32. The method of claim 31, wherein the optimal temperature for crystal growth ranges from about 220 to 280 degrees Celsius.

33. The method of claim 14, further comprising placing the reaction vessel under an inert gas prior to introducing the stock solution.

34. The method of claim 14, wherein the crystals of luminescent matter grow in the reaction vessel for a period ranging from about 15 to 120 seconds.

35. The method of claim 14, wherein the crystals of luminescent matter are purified using centrifuging.

36. The method of claim 36, wherein the crystals are dispersed in a solvent prior to centrifuging.

37. The method of claim 36, wherein the centrifuging is repeated at least once.

38. The method of claim 14, wherein the semiconductor nanocrystal serves as an antenna for excitation of the lanthanide cation.

39. The method of claim 14, wherein the semiconductor nanocrystal mitigates non-radiative deactivation of excited states of the lanthanide cation.

40. The method of claim 14, wherein both the semiconductor nanocrystal and the lanthanide cation exhibit luminescence.

41. The method of claim 14, wherein the semiconductor nanocrystal has a size of less than about 100 nm.

42. The method of claim 14, wherein the semiconductor nanocrystal has a size that ranges from about 2 to 20 microns.

43. The method of claim 14, wherein the molar ratio of semiconductor material to lanthanide cation ranges from about 80:20 to 90:10.

44. The method of claim 14, wherein the lanthanide cation has a luminescence lifetime that ranges from about 2 to 3 ms.
